(19) United States
(12) Patent Application Publication
(10) Pub. No.: US 2024/0101432 A1
(43) Pub. Date: Mar. 28, 2024

(54) METHOD OF MANUFACTURING SILICON-BASED ANODE ACTIVE MATERIAL AND MANUFACTURING EQUIPMENT IMPLEMENTING SUCH METHOD

(71) Applicant: Blue star advanced materials Co., Ltd., New Taipei City (TW)

(72) Inventor: Chung-Wen LAN, Taipei City (TW)

(21) Appl. No.: 18/472,998

(22) Filed: Sep. 22, 2023

(30) Foreign Application Priority Data
Sep. 23, 2022 (TW) 111136100

(51) Int. Cl. C01B 33/021; C01D 15/00

(52) U.S. Cl. CPC C01B 33/021; C01D 15/00; C01P 2004/84; C01P 2006/40

(57) ABSTRACT

A method of manufacturing a silicon-based anode active material is, firstly, to prepare a plurality of silicon-based particles which each is coated with a carbon film. Then, the method of the invention is to immerse the silicon-based particles and a lithium source into a carrier solution, and to heat the carrier solution to obtain a plurality of lithium-containing silicon-based particles. Next, the method of the invention is to heat the lithium-containing silicon-based particles in an inert furnace atmosphere to homogenize the lithium-containing silicon-based particles. Finally, the method of the invention is to immerse the homogenized lithium-containing silicon-based particles into a passivation environment, and to heat the carrier solution to passivate the homogenized lithium-containing silicon-based particles. The passivated and homogenized lithium-containing silicon-based particles serve as the silicon-based anode active material.

### CROSS-REFERENCE TO RELATED APPLICATION

This utility application claims priority to Taiwan Application Serial Number 111136100, filed Sep. 23, 2022, which is incorporated herein by reference.

### BACKGROUND OF THE INVENTION

### 1. Field of the Invention

The invention relates to a method of manufacturing a silicon-based anode active material and a manufacturing equipment for implementing such method, and more in particular, to a method of manufacturing a plurality of passivated and homogenized lithium-containing silicon-based particles, which serve as a silicon-based anode active material, and a manufacturing equipment for implementing such method.

Regarding the relevant technical background of this present invention, please refer to the references listed below:
[1] Casimir A, Zhang H, Ogoke O, Amine J C, Lu J, Wu G., “Silicon-based anodes for lithium-ion batteries: Effectiveness of materials synthesis and electrode preparation”, Nano Energy. 2016; 27:359-376.
[2] Li Z, He Q, He L, Hu P, Li W, Yan H, et al., “Self-sacrificed synthesis of carbon-coated SiOₓ nanowires for high capacity lithium ion battery anodes”, Journal of Materials Chemistry A. 2017; 5:4183-4189.
[3] Parimalam B S, Mac Intosh A D, Kadam R, Lucht B L, “Decomposition reactions of anode solid electrolyte interphase (SEI) components with LiPF6” The Journal of Physical Chemistry C. 2017; 121:22733-22738.
[4] Japan Patent Application Publication No. JP2018511969A.

### 2. Description of the Prior Art

Silicon oxide particles with high purity have been used in the manufacture of a number of commercially valuable products, such as production of hydrogen, manufacture of anodes of lithium ion batteries, and manufacture of silicon dioxide and silicon carbide.

Taking lithium-ion batteries as an example to illustrate, lithium-ion batteries have been widely commercialized as an energy storage technology with the advantages of high energy density, high discharge voltage, low internal resistance, small self-discharge, no memory effect, and environmentally friendly and non-polluting. Lithium-ion batteries have been widely used in various products, such as cell phones, notebook computers, hearing aids, cameras, and electric vehicles. In addition, lithium-ion batteries are also widely used in torpedoes, airplanes, microelectromechanical systems and other modern high-tech fields. Therefore, lithium-ion batteries are the ideal new energy source for human beings. However, the existing commercialized lithium-ion batteries still have many shortcomings, making the application of high-energy power supply cannot meet the demand. In terms of anode alone, most commercialized lithium-ion batteries use graphite and other carbon materials as the anode. This is because the anode made of graphite has the advantages of good conductivity and long cycle life. However, the graphite anode has a low specific capacity (the theoretical specific capacity of graphite is only 372 mAh/g), which is far from being able to satisfy the capacity demand of high-capacity power systems. Therefore, the development of high-capacity anode material with excellent performance has become a hot research topic.

Silicon material has higher theoretical lithium storage capacity, low de-embedded lithium potential (0.2-0.3V vs. Li/Li+), and silicon is an element that is abundantly found on earth. Therefore, silicon is considered to be the most likely anode material to replace graphite. Silicon and lithium can form Li—Si alloys with various phases such as Li1₂Si₇, Li₇Si₃, Li₁₃Si₄, and Li₂₂Si₅, etc. The theoretical capacity of Li—Si alloys reaches up to 4,200 mAh/g, which is the highest among the various alloys of anode materials studied so far. Moreover, lithium embedded in silicon has a lower voltage, and there is no co-embedding of solvent molecules during the embedding process, which makes silicon very suitable for use as an anode material in lithium-ion batteries [1]. However, the large volume expansion rate (˜400%) of Si anodes leads to degradation of Si particles and damage of SEI film [2-3]. These problems can cause dramatic degradation and even overall damage of the capacity, thus hindering the commercialization of silicon anode for lithium-ion batteries.

Due to lower oxygen content of SiOₓ, (0<x<2) enhanced cyclic stability, SiOₓ has attracted considerable research as a potential alternative to Si. SiOₓ not only exhibits a relatively small volume expansion rate, but also forms Li₂O as well as lithium silicate, which are used as a buffer mediator for Si in the first lithiation process. As a result, SiOₓ exhibits better cyclic properties than Si. Hereinafter, the chemical formula of the silicon oxide particles referred to in the present invention is SiOₓ, 0<x<2.

For anodes made from micrometer-scale and nanometer-scale spherical particles of silicon oxide, the uniformity of the particle size of silicon oxide particles affects the characteristics of the anode. The more uniform the particle size distribution of silicon oxide particles, the better the characteristics of the anode made from silicon oxide particles. If silicon oxide particles can be produced with good uniformity of particle size distribution, the commercial value of silicon oxide particles can increase.

In order to increase the capacity and improve the initial coulombic efficiency (ICE) of lithium-ion batteries with anode made from silicon oxide particles, the silicon oxide particles need to be pre-lithiated.

Prior arts have used a lithium-containing pre-lithiation solution, immersed silicon oxide particles in the lithium-containing pre-lithiation solution, and heated the lithium-containing pre-lithiation solution for the pre-lithiation of the silicon oxide particles [4]. This pre-lithiation way is also known as chemical pre-lithiation. The pre-lithiation solution of the prior arts includes more than one of biphenyl, biphenyltriphenyl, and derivatives thereof, which is mixed with a solvent of ether series. However, the prior arts must prepare a lithium-containing pre-lithiation solution in which biphenyl, biphenyltriphenyl and derivatives thereof are the carriers. The Mole ratio of lithium to carrier in the lithium-containing pre-lithiation solution used in the prior arts is less than 4, which increases the cost of separating lithium from the carrier.

Moreover, the pH value of lithium-containing silicon oxide particles produced by chemical pre-lithiation in the prior arts is higher than 12. When lithium-containing silicon oxide particles are mixed with an adhesive to form an anode coating, the adhesive decomposes under high alkalinity, which significantly reduces the viscosity of the anode coating. This makes it necessary to increase the solids content to complete the coating of the anode. Also, because of the degradation of the adhesive, the anodes are formed with poor mechanical strength. In addition, the chemical pre-lithiation method of the prior arts is stage-by-stage processes including removal process, cleaning process and drying process. These processes did not easily avoid air and moisture, which could lead to the risk of an explosion. Obviously, there is still space for improvement in the chemical pre-lithiation method of the prior arts.

In addition, the prior arts of adopting chemical pre-lithiation have not yet been proposed as a one-time process and equipment, nor has it been proposed as a technology to significantly reduce the amount of carrier and to recover the carrier and solvent.

### SUMMARY OF THE INVENTION

Accordingly, one scope of the invention is to provide a method of manufacturing a plurality of passivated and homogenized lithium-containing silicon-based particle, which serves as a silicon-based anode active material, and a manufacturing equipment for implementing such method.

A method of manufacturing an anode active material, according to a preferred embodiment of the invention, is, firstly, to prepare a plurality of silicon-based particles. Each of the silicon-based particles is coated with a carbon film, and has a chemical formula of SiOₓ/C, 0<x<2. Next, the method according to the preferred embodiment of the invention is to immerse the silicon-base particles and a lithium source into a carrier solution, and to heat, in an inert furnace atmosphere, the carrier solution to a first temperature for a first period of time to obtain a plurality of lithium-containing silicon-based particles. The carrier solution consists of a polycyclic aromatic hydrocarbon mixed with a solvent. A mole ratio of the lithium source to the polycyclic aromatic hydrocarbon is equal to or greater than 5. A volume ratio of the solvent to the silicon-based particles is equal to or greater than 1. The polycyclic aromatic hydrocarbon can be a biphenyl, a naphthalene, a biphenyl containing a functional group or a mixture therebetween. The solvent can be a first tetrahydrofuran, a dimethoxyethane, an N-methyl-2-pyrrolidone or a mixture therebetween. The first temperature ranges from 50° C. to 250° C., the first period of time ranges from 1 hour to 24 hours. Afterward, the method according to the preferred embodiment of the invention is, in an inert furnace atmosphere, to heat the lithium-containing silicon-based particles to a second temperature for a second period of time to homogenize the lithium-containing silicon-based particles. The second temperature ranges from 550° C. to 850° C. The second period of time ranges from 1 hour to 16 hours. Finally, the method according to the preferred embodiment of the invention is to immerse the homogenized lithium-containing silicon-based particles into a passivation solution or a passivation gas, and to heat the homogenized lithium-containing silicon-based particles to a third temperature for a third period of time to passivate the homogenized lithium-containing silicon-based particle. The passivation solution consists of a hexane mixed with a perfluorotripentylamine (FC70) or a second tetrahydrofuran mixed with a hydrofluoric acid. A first weight percentage of the perfluorotripentylamine is equal to or less than 5 wt. %. A second weight percentage of the hydrofluoric acid is equal to or less than 10 wt. %. The passivation gas is a nitrogen trifluoride or a chlorofluorocarbon (Freon). The third temperature ranges from 30° C. to 250° C. The third period of time ranges from 10 minutes to 24 hour. The passivated and homogenized lithium-containing silicon-based particles serve as the silicon-based anode active material.

In one embodiment, a concentration of the carrier solution ranges from 0.025M to 2M.

In one embodiment, the mole ratio of the lithium source to the polycyclic aromatic hydrocarbon ranges from 5 to 100.

In one embodiment, a pH value of the silicon-based anode active material is equal to or less than 12.

In one embodiment, in the step of homogenizing the lithium-containing silicon-based particles, a phosphorus or a boron is added to generate a phosphorus oxide or a boron oxide on a surface of one of the plurality of lithium-containing silicon-based particles, and further to reduce the pH value of the silicon-based anode active material. A weight ratio of an amount of the phosphorus or boron added to the plurality of lithium-containing silicon-based particles is equal to or less than 10%.

A manufacturing equipment for manufacturing an anode active material, according to a preferred embodiment of the invention, includes a stirred reaction chamber, an inert gas supply source, a solvent supply source, a passivation source supply source, a first recycling apparatus, and a second recycling apparatus. A plurality of silicon-based particles, a lithium source and a polycyclic aromatic hydrocarbon are placed into the stirred reaction chamber. Each of the silicon-based particles is coated with a carbon film, and has a chemical formula of SiOₓ/C, 0<x<2. The stirred reaction chamber is sealed. The polycyclic aromatic hydrocarbon can be a biphenyl, a naphthalene, a biphenyl containing a functional group or a mixture therebetween. The inert gas supply source communicates with the stirred reaction chamber, and therein stores an inert gas. The solvent supply source communicates with the stirred reaction chamber, and therein contains a solvent. The solvent can be a first tetrahydrofuran, a dimethoxyethane, an N-methyl-2-pyrrolidone or a mixture therebetween. The passivation source supply source communicates with the stirred reaction chamber, and therein contains a passivation solution or a passivation gas. The passivation solution consists of a hexane mixed with a perfluorotripentylamine (FC70) or a second tetrahydrofuran mixed with a hydrofluoric acid. A first weight percentage of the perfluorotripentylamine is equal to or less than 5 wt. %. A second weight percentage of the hydrofluoric acid is equal to or less than 10 wt. %. The passivation gas is a nitrogen trifluoride or a chlorofluorocarbon (Freon). The first recycling apparatus communicates with the stirred reaction chamber. A second recycling apparatus communicates with the stirred reaction chamber. The solvent supply source supplies the solvent to the stirred reaction chamber, where the polycyclic aromatic hydrocarbon is mixed with the solvent to form a carrier solution. The plurality of silicon-based particles and the lithium source are immersed into the carrier solution. The inert gas supply source supplies the inert gas to the stirred reaction chamber resulting in an inert furnace atmosphere in the stirred reaction chamber. The stirred reaction chamber is heated to a first temperature for a first period of time to obtain a plurality of lithium-containing silicon-based particles. The first temperature ranges from 50° C. to 250° C. The first period of time ranges from 1 hour to 24 hours. The first recycling apparatus recycles the carrier solution. The stirred reaction chamber is, in the inert furnace atmosphere, heated to a second temperature for a second period of time to homogenize the lithium-containing silicon-based particles. The second temperature ranges from 550° C. to 850° C. The second period of time ranges from 1 hour to 16 hours. The passivation source supply source supplies the passivation solution or the passivation gas to the stirred reaction chamber. The stirred reaction chamber is heated to a third temperature for a third period of time to passivate the homogenized lithium-containing silicon-based particles. The third temperature ranges from 30° C. to 250° C. The third period of time ranges from 10 minutes to 24 hours. The second recycling apparatus recycles the passivation solution or the passivation gas. The passivated and homogenized lithium-containing silicon-based particles serve as the silicon-based anode active material.

In one embodiment, when the first recycling apparatus recycles the carrier solution, the reaction chamber is heated higher than a boiling point of the carrier solution.

Different from the chemical pre-lithiation method of the prior arts, the method according to the invention has a mole ratio of the lithium source to the carrier is equal to or greater than 5. Moreover, the plurality of passivated and homogenized lithium-containing silicon-based particles, made by the method according to the invention, has a pH value equal to or less than 12, which makes the silicon-based anode active material easy to produce an anode of a battery. Moreover, the manufacturing equipment according to the invention is a one-time processing equipment, and there is no stage of drying or cleaning taken out during the process implemented by the manufacturing equipment according to the invention, so there is no risk of causing an explosion by using the manufacturing equipment according to the invention. Moreover, the manufacturing equipment according to the invention can significantly reduce the amount of carrier and recover the carrier and solvent for the manufacture of the silicon-based anode active material by chemical pre-lithiation.

The advantage and spirit of the invention may be understood by the following recitations together with the appended drawings.

### BRIEF DESCRIPTION OF THE APPENDED DRAWINGS

FIG. 1 is a flowchart illustrating a method of manufacturing a silicon-based anode active material according to the preferred embodiment of the invention.

FIGS. 2 through 6 are schematic diagrams illustrating the architecture of the manufacturing equipment according to the preferred embodiment of the invention at various stages of manufacturing.

FIG. 7 is a bar chart diagram showing the specific capacity and initial coulombic efficiency curves of an anode of a battery made from passivated and homogenized silicon oxide particles coated with a carbon film and doped with 9 wt. % of sodium in an example of the invention for different homogenization times.

FIG. 7 is a data diagram showing the charging and discharging capacities and the initial coulombic efficiencies of the anodes made in the example of the invention as well as the comparative example.

FIG. 8 is a data diagram showing the thicknesses and pH values of LiF layers formed on the surface of lithium-containing silicon-based particles of the examples of the invention for different passivation times, as well as on the surfaces of the comparative example.

FIG. 9 is a data diagram showing the weight gain of the lithium-containing silicon-based particles after homogenization and passivation in the example of the invention and the weight gain of the lithium-containing silicon-based particles after homogenization and without passivation in the comparative example, without passivation for different placement times in the air.

### DETAILED DESCRIPTION OF THE INVENTION

Some preferred embodiments and practical applications of this present invention would be explained in the following paragraph, describing the characteristics, spirit, and advantages of the invention.

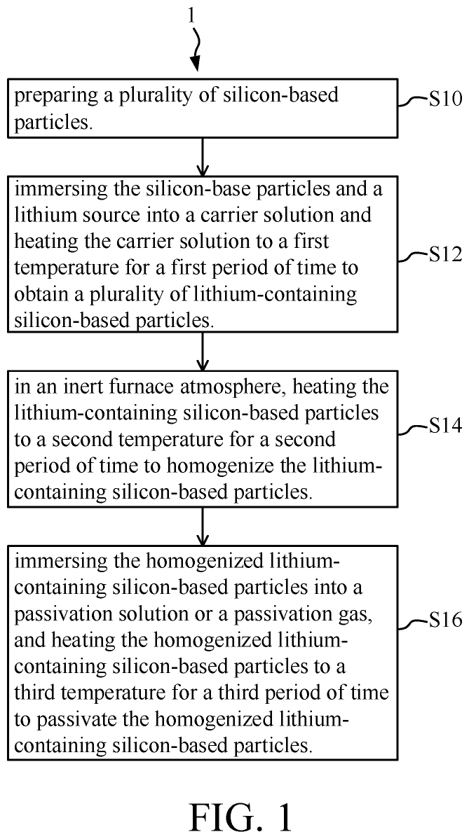

Referring to FIG. 1, FIG. 1 is a flowchart illustrating a method 1 of manufacturing a silicon-based anode active material according to the preferred embodiment of the invention.

As shown in FIG. 1, the method 1 according to the preferred embodiment of the invention, firstly, performs step S10 to prepare a plurality of silicon-based particles. Each of the silicon-based particles is coated with a carbon film, and has a chemical formula of SiOₓ/C, 0<x<2. Many methods have been proposed for the preparation of the SiOₓ/C particles, and will be not described in detail herein.

Next, the method 1 according to the preferred embodiment of the invention performs step S12 to immerse the silicon-base particles and a lithium source (e.g., lithium foil) into a carrier solution, and to heat, in an inert furnace atmosphere (e.g., argon, neon, helium, etc.), the carrier solution to a first temperature for a first period of time to obtain a plurality of lithium-containing silicon-based particles. The carrier solution consists of a polycyclic aromatic hydrocarbon mixed with a solvent. A mole ratio of the lithium source to the polycyclic aromatic hydrocarbon is equal to or greater than 5. A volume ratio of the solvent to the silicon-based particles is equal to or greater than 1. The polycyclic aromatic hydrocarbon can be a biphenyl, a naphthalene, a biphenyl containing a functional group or a mixture therebetween. The solvent can be a first tetrahydrofuran, a dimethoxyethane, an N-methyl-2-pyrrolidone or a mixture therebetween. The first temperature ranges from 50° C. to 250° C., the first period of time ranges from 1 hour to 24 hours. In practical applications, the plurality of silicon-based particles coated with a carbon film can, to a certain extent, prevent the degradation of electrical conductivity caused by lithium doping.

The carrier solution consists of a polycyclic aromatic hydrocarbon mixed with a solvent. The polycyclic aromatic hydrocarbon is used as a carrier. In particular, because the lithium source slowly dissolves into the carrier solution, this results in a mole ratio of the lithium source to the polycyclic aromatic hydrocarbons (i.e., the carrier) equal to or greater than 5.

In one embodiment, the mole ratio of the lithium source to the polycyclic aromatic hydrocarbon ranges from 5 to 100.

In one embodiment, a concentration of the carrier solution ranges from 0.025M to 2M.

A volume ratio of the solvent to the silicon-based particles is equal to or greater than 1. The polycyclic aromatic hydrocarbon can be a biphenyl, a naphthalene, a biphenyl containing a functional group or a mixture therebetween. The solvent can be a first tetrahydrofuran (THF), a dimethoxyethane, an N-methyl-2-pyrrolidone (NMP) or a mixture therebetween. The first temperature ranges from 50° C. to 250° C., the first period of time ranges from 1 hour to 24 hours.

Afterward, the method 1 according to the preferred embodiment of the invention performs step 14, in an inert furnace atmosphere, to heat the lithium-containing silicon-based particles to a second temperature for a second period of time to homogenize the lithium-containing silicon-based particles. The second temperature ranges from 550° C. to 850° C. The second period of time ranges from 1 hour to 16 hours.

Finally, the method 1 according to the preferred embodiment of the invention perform strep 16 to immerse the homogenized lithium-containing silicon-based particles into a passivation solution or a passivation gas, and to heat the homogenized lithium-containing silicon-based particles to a third temperature for a third period of time to passivate the homogenized lithium-containing silicon-based particle. The passivated and homogenized lithium-containing silicon-based particles serve as the silicon-based anode active material.

The passivation solution can be made by mixing a non-polar solvent such as hexane with a perfluorotripentylamine (FC70) or by mixing a second tetrahydrofuran with a hydrofluoric acid. A first weight percentage of the perfluorotripentylamine is equal to or less than 5 wt. %. A second weight percentage of the hydrofluoric acid is equal to or less than 10 wt. %. The passivation gas is a nitrogen trifluoride or a chlorofluorocarbon (Freon). The third temperature ranges from 30° C. to 250° C. The third period of time ranges from 10 minutes to 24 hour.

In one embodiment, a pH value of the silicon-based anode active material, which just is passivated and homogenized lithium-containing silicon-based particles, is equal to or less than 12. The silicon-based anode active material having a pH value equal to or less than 12 manufactured by the method 1 according to the invention can be easily mixed with an adhesive to form an anode coating, which has a high viscosity and can be coated without increasing the solids content, and thus can be easily formed into an anode. The proportion of adhesive ranges from 5 to 15 wt. %.

In one embodiment, in the step of homogenizing the lithium-containing silicon-based particles, a phosphorus or a boron is added to generate a phosphorus oxide or a boron oxide on a surface of one of the plurality of lithium-containing silicon-based particles, and further to reduce the pH value of the silicon-based anode active material. A weight ratio of an amount of the phosphorus or boron added to the plurality of lithium-containing silicon-based particles is equal to or less than 10%.

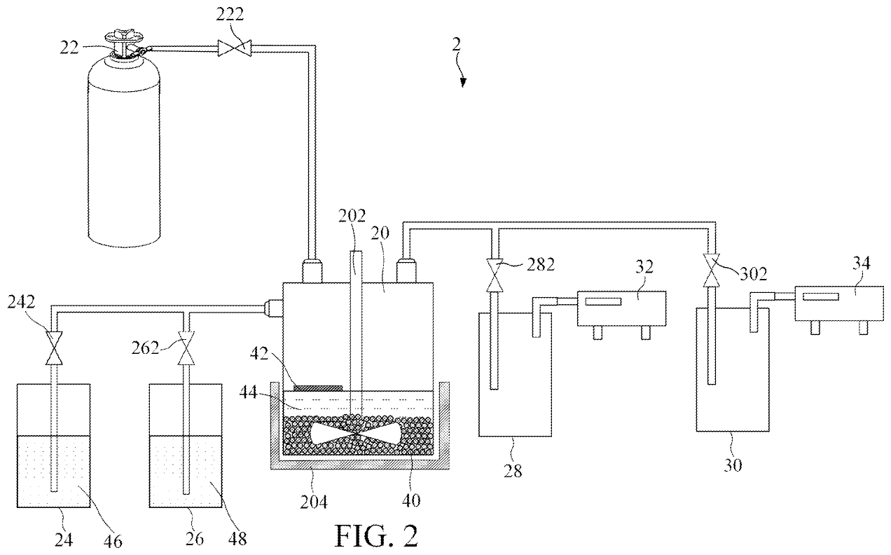

Referring to FIGS. 2 through 6, those drawings schematically illustrate the architecture of the manufacturing equipment 2 for manufacturing a silicon-based anode active material according to a preferred embodiment of the invention at various stages of the manufacturing. In FIGS. 2 to 6, some of the devices and apparatuses are shown in cross-sectional or partial perspective views.

As shown in FIGS. 2 through 6, the manufacturing equipment 2 for manufacturing an anode active material, according to the preferred embodiment of the invention, includes a stirred reaction chamber 20, an inert gas supply source 22, a solvent supply source 24, a passivation source supply source 26, a first recycling apparatus 28, and a second recycling apparatus 30.

The manufacturing equipment 2 according to the present invention further includes a stirring device 202. The stirring device 202 is disposed so as to operate inside the stirred reaction chamber 20. The manufacturing equipment 2 according to the invention further includes a heater 204 which is disposed to surround the stirred reaction chamber 20.

A plurality of silicon-based particles 40, a lithium source 42 (e.g., lithium foil or lithium particles) and a polycyclic aromatic hydrocarbon 44 are placed into the stirred reaction chamber 20 as shown in FIG. 2. Each of the silicon-based particles sis coated with a carbon film, and has a chemical formula of SiOₓ/C, 0<x<2. The stirred reaction chamber 20 is sealed. The amount of oxidation of the lithium source 42 before it is placed into the stirred reaction chamber 20 can be ignored in the manufacturing the silicon-based anode active material by the manufacturing equipment 2 according to the invention. The polycyclic aromatic hydrocarbon 44 is used as a carrier. The polycyclic aromatic hydrocarbon 44 can be a biphenyl, a naphthalene, a biphenyl containing a functional group or a mixture therebetween.

The inert gas supply source 22 communicates with the stirred reaction chamber 20, and therein stores an inert gas (e.g., argon, neon, helium, etc.). The manufacturing equipment 2 according to the invention also includes a control valve 222, which is installed between the stirred reaction chamber 20 and the inert gas supply source 22.

The solvent supply source 24 communicates with the stirred reaction chamber 20, and therein contains a solvent. The solvent can be a first tetrahydrofuran (THF), a dimethoxyethane, an N-methyl-2-pyrrolidone (NMP) or a mixture therebetween. The manufacturing equipment 2 according to the invention also includes a control valve 242, which is installed between the stirred reaction chamber 20 and the solvent supply source 24.

The passivation source supply source 26 communicates with the stirred reaction chamber 20, and therein contains a passivation solution 48 (as shown in FIG. 2 to FIG. 6) or a passivation gas. The passivation solution 48 consists of a hexane mixed with a perfluorotripentylamine (FC70) or a second tetrahydrofuran mixed with a hydrofluoric acid. A first weight percentage of the perfluorotripentylamine is equal to or less than 5 wt. %. A second weight percentage of the hydrofluoric acid is equal to or less than 10 wt. %. The passivation gas is a nitrogen trifluoride or a chlorofluorocarbon (Freon). The manufacturing equipment 2 according to the invention also includes a control valve 262, which is installed between the stirred reaction chamber 20 and the passivation source supply source 26.

The first recycling apparatus 28 communicates with the stirred reaction chamber 20. The manufacturing equipment 2 according to the invention also includes a control valve 282, which is installed between the stirred reaction chamber 20 and the first recycling apparatus 28.

A second recycling apparatus 30 communicates with the stirred reaction chamber 20. The manufacturing equipment 2 according to the invention also includes a control valve 302, which is installed between the stirred reaction chamber 20 and the second recycling apparatus 30.

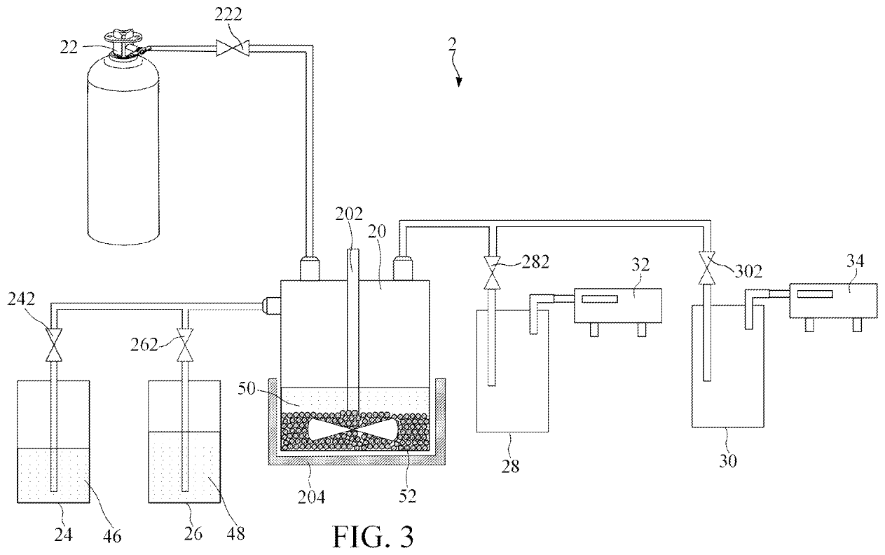

As shown in FIG. 3, in the manufacturing of a silicon-based anode active material by the manufacturing equipment 2 according to the present invention, thereafter, the control valve 242 is opened and the solvent 46 is supplied from the solvent supply source 24 into the stirred reaction chamber 20, where the polycyclic aromatic hydrocarbons 44 are mixed with the solvent 46 to form the carrier solution 50. The plurality of silicon-based particles 40 and the lithium source 42 are immersed into the carrier solution 50. The control valve 222 is opened and the inert gas supply source 22 supplies the inert gas to the stirred reaction chamber 20 resulting in an inert furnace atmosphere in the stirred reaction chamber 20. It should be emphasized that because the lithium source 42 slowly dissolves into the carrier solution 50, this results in a mole ratio of the lithium source 42 to the polycyclic aromatic hydrocarbons 44 (i.e., the carrier) equal to or greater than 5.

Also as shown in FIG. 3, the stirred reaction chamber 20 can be heated by the heater 204 to a first temperature for a first period of time to obtain a plurality of lithium-containing silicon-based particles 52. The first temperature ranges from 50° C. to 250° C. The first period of time ranges from 1 hour to 24 hours.

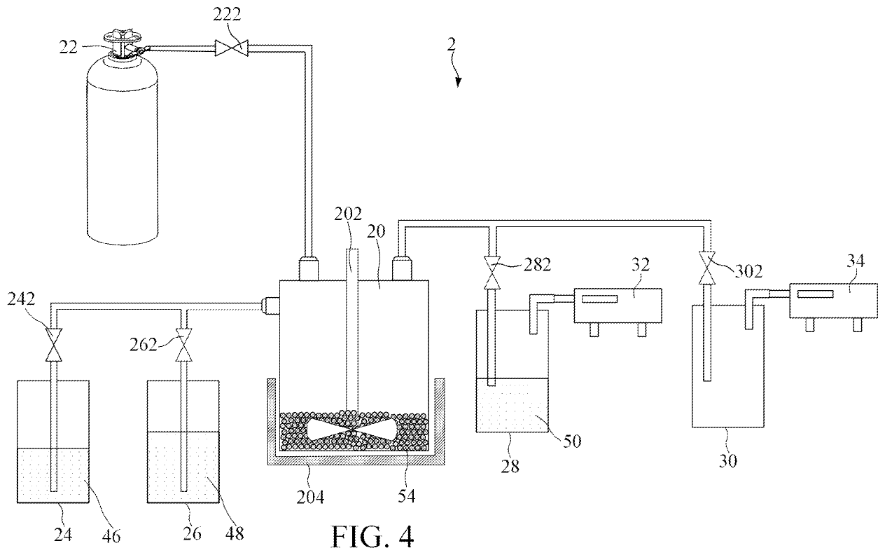

As shown in FIG. 4, the first recycling apparatus 28 recycles the carrier solution 50.

During the recycling of the carrier solution 50, the control valve 282 is opened. The manufacturing equipment 2 according to the invention also includes a vacuum extraction apparatus 32. The vacuum extraction apparatus 32 communicates behind the first recycling apparatus 28. The vacuum extraction apparatus 32 is used to create a vacuum environment inside the first recycling apparatus 28 for recovery of the carrier solution 50.

In one embodiment, when the first recycling apparatus 28 recycles the carrier solution 50, the stirred reaction chamber 20 may be heated higher than the boiling point of the carrier solution 50 by the heater 204.

Also as shown in FIG. 4, the stirred reaction chamber 20 can be heated by the heater 204, in the inert furnace atmosphere, to a second temperature for a second period of time to homogenize the lithium-containing silicon-based particles 52 into a plurality of homogenized lithium-containing silicon-based particles 54. The second temperature ranges from 550° C. to 850° C. The second period of time ranges from 1 hour to 16 hours.

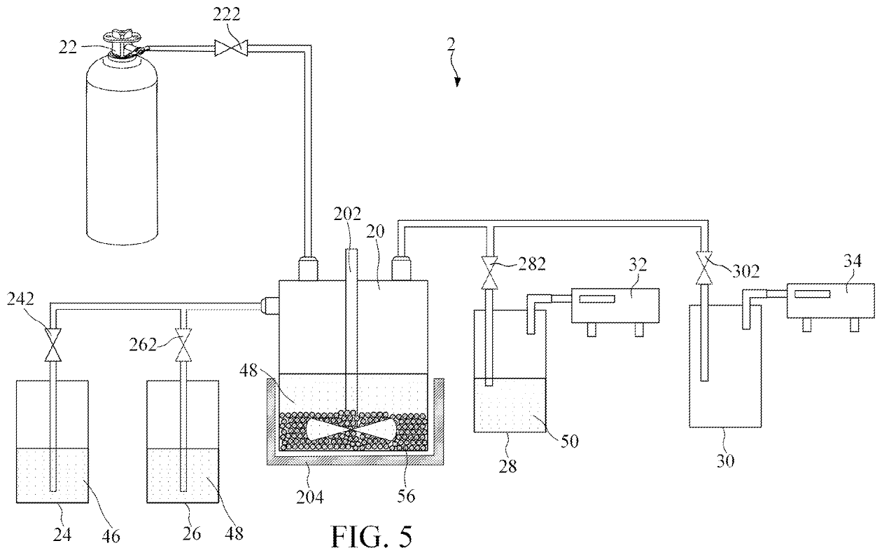

As shown in FIG. 5, the control valve 262 is opened and the passivation source supply source 26 supplies the passivation solution 48 or the passivation gas to the stirred reaction chamber 20. The stirred reaction chamber 20 can be heated by the heater 204 to a third temperature for a third period of time to passivate the homogenized lithium-containing silicon-based particles 54 inti a plurality of passivated and homogenized lithium-containing silicon-based particles 56. The third temperature ranges from 30° C. to 250° C. The third period of time ranges from 10 minutes to 24 hours.

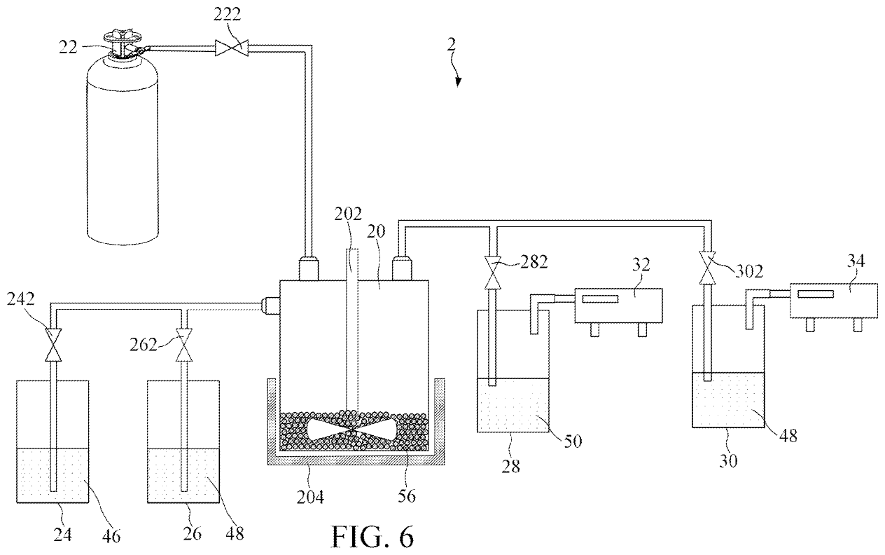

As shown in FIG. 6, the second recycling apparatus 30 recycles the passivation solution 48 or the passivation gas. During the recycling of the passivation solution 48 or the passivation gas, the control valve 302 is opened. The manufacturing equipment 2 according to the invention also includes a vacuum extraction apparatus 34. The vacuum extraction apparatus 34 communicates behind the second recycling apparatus 30. The vacuum extraction apparatus 34 is used to create a vacuum environment inside the second recycling apparatus 30 for recovery of the passivation solution 48 or the passivation gas.

The passivated and homogenized lithium-containing silicon-based particles 56 serve as the silicon-based anode active material manufactured by the manufacturing equipment 2 according to the invention.

Obviously, the manufacturing equipment 2 according to the invention is a one-time processing equipment, and there is no stage of drying or cleaning taken out during the process implemented by the manufacturing equipment 2 according to the invention, so there is no risk of causing an explosion by using the manufacturing equipment 2 according to the invention. Moreover, the manufacturing equipment according to the invention can significantly reduce the amount of carrier and recover the carrier and solvent for the manufacture of the silicon-based anode active material by chemical pre-lithiation.

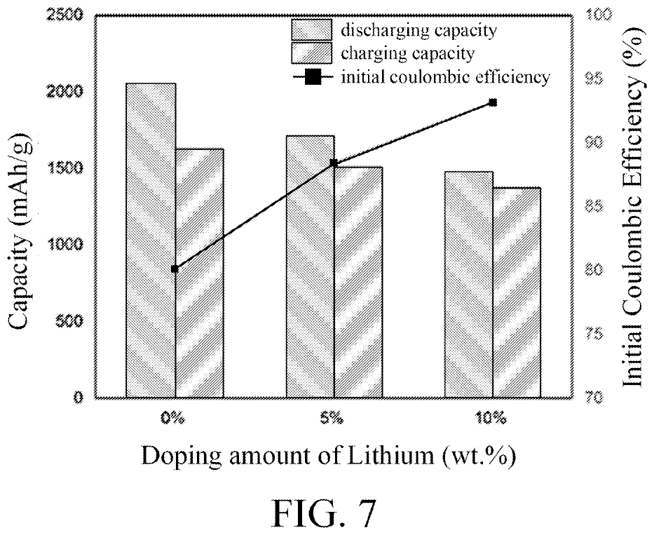

Two examples of the invention are: (1) 5 wt. % lithium at the second temperature of 750° C. for the second period of time of 2 hours, and at the third temperature of 160° C. for the third period of time of 2 hours; (2) 10 wt. % lithium at the second temperature of 750° C. for the second period of time of 2 hours, and at the third temperature of 160° C. for the third period of time of 2 hours. And, a comparative example is: 0 wt. % lithium at the second temperature of 750° C. for the second period of time of 2 hours, and at the third temperature of 160° C. for the third period of time of 2 hours. The silicon-based anode active materials of the examples of the invention and the comparative example are further fabricated into the anodes of a battery. The charging and discharging capacities and the initial coulombic efficiencies of the half-batteries with these anodes are measured and shown in FIG. 7. FIG. 7 confirms that as the amount of pre-lithium increases, the reversible charging and discharging capacities of the half-batteries become closer to each other, and the initial coulombic efficiencies of the half-batteries increase. Among these half-batteries, the half-battery having the anode doped with 10 wt. % lithium has the highest initial coulombic efficiency of over 93%.

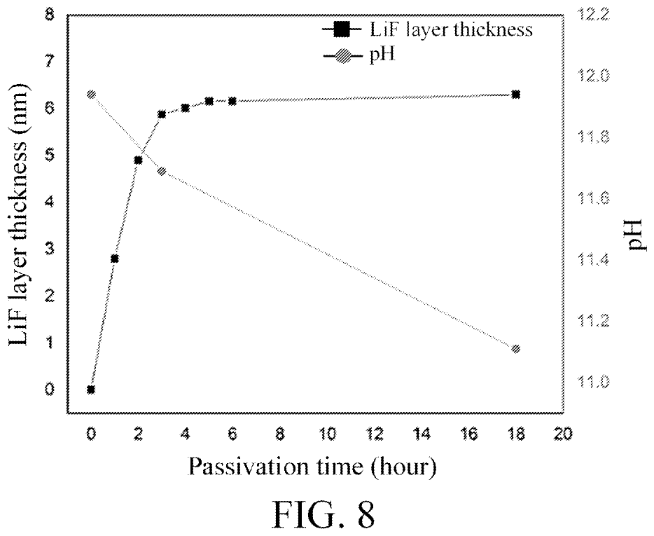

In several examples of the invention, the lithium-containing silicon-based particles are passivated in a nitrogen trifluoride after homogenization at a passivation temperature of 160° C. The effects of different passivation times on the thickness of the LiF layer on the surface of lithium-containing silicon-based particles and on the pH value of the lithium-containing silicon-based particles are shown in FIG. 8. For comparison, the LiF layer thickness and pH value of lithium-containing silicon-based particles after homogenization without passivation are also shown in FIG. 8. FIG. 8 confirms that as the passivation time increases, the LiF layer thickness increases until the increase in LiF layer thickness levels off after 5 hours of passivation time. FIG. 8 also shows that the pH of the lithium-containing silicon-based particles before passivation is about 11.95. As the passivation time increases, the pH of the lithium-containing silicon-based particles decreases until the pH of the lithium-containing silicon-based particles dropped to about 11.1 after 18 hours of passivation.

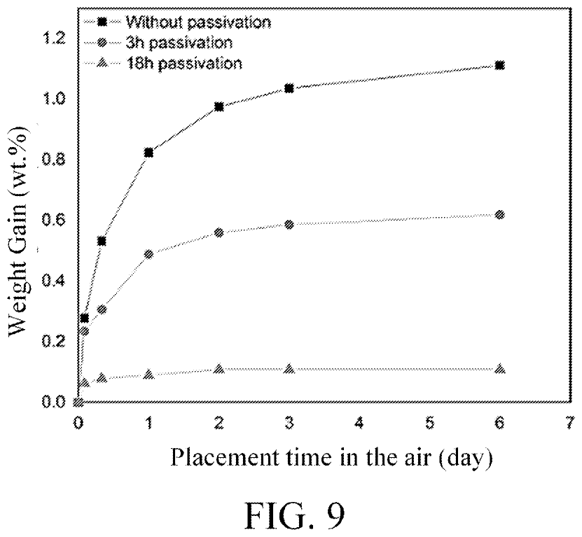

In two examples of the invention, a plurality of lithium-containing silicon-based particles after homogenization are passivated in a nitrogen trifluoride at a passivation temperature of 160° C. respectively for 3 hours and 18 hours to obtain a plurality of passivated and homogenized lithium-containing silicon-based particles. The passivated and homogenized lithium-containing silicon-based particles in the above two examples of the invention are subjected to oxidization in the air, and the weight gains of the oxidized lithium-containing silicon-based particles measured with the increase of placement time in the air are shown in FIG. 9.

In contrast, a plurality of and homogenized lithium-containing silicon-based particles without passivation of a comparative example are subjected to oxidization in the air, and the weight gains of the oxidized lithium-containing silicon-based particles measured with the increase of placement time in the air also are shown in FIG. 9. FIG. 9 confirms that the homogenized lithium-containing silicon-based particles with passivation are relatively stable in the air. The homogenized lithium-containing silicon-based particles with passivation for 18 hours are more stable in the air than the homogenized lithium-containing silicon-based particles with passivation for 3 hours.

With the detailed description of the above preferred embodiments of the invention, it is clear to understand that the method according to the invention has a mole ratio of the lithium source to the carrier is equal to or greater than 5. Moreover, the plurality of passivated and homogenized lithium-containing silicon-based particles, made by the method according to the invention, has a pH value equal to or less than 12, which makes the silicon-based anode active material easy to produce an anode of a battery. Moreover, the manufacturing equipment according to the invention is a one-time processing equipment, and there is no stage of drying or cleaning taken out during the process implemented by the manufacturing equipment according to the invention, so there is no risk of causing an explosion by using the manufacturing equipment according to the invention. Moreover, the manufacturing equipment according to the invention can significantly reduce the amount of carrier and recover the carrier and solvent for the manufacture of the silicon-based anode active material by chemical pre-lithiation.

With the detailed description of the above preferred embodiments of the invention, it is clear to understand that the method according to the invention can manufacture a plurality of silicon nano-powders with easy shape control, high purity and mass production. The manufacturing equipment according to the invention is beneficial to the mass production of a plurality of silicon nano-powders with high purity.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method of manufacturing a silicon-based anode active material, comprising the steps of:
preparing a plurality of silicon-based particles, wherein each of the silicon-based particles is coated with a carbon film, and has a chemical formula of SiOₓ/C, 0<x<2;
immersing the silicon-base particles and a lithium source into a carrier solution and heating, in an inert furnace atmosphere, the carrier solution to a first temperature for a first period of time to obtain a plurality of lithium-containing silicon-based particles, wherein the carrier solution consists of a polycyclic aromatic hydrocarbon mixed with a solvent, a mole ratio of the lithium source to the polycyclic aromatic hydrocarbon is equal to or greater than 5, a volume ratio of the solvent to the silicon-based particles is equal to or greater than 1, the polycyclic aromatic hydrocarbon is one selected from the group consisting of a biphenyl, a naphthalene, a biphenyl containing a functional group and a mixture therebetween, the solvent is one selected from the group consisting of a first tetrahydrofuran, a dimethoxyethane, an N-methyl-2-pyrrolidone and a mixture therebetween, the first temperature ranges from 50° C. to 250° C., the first period of time ranges from 1 hour to 24 hours;
in an inert furnace atmosphere, heating the lithium-containing silicon-based particles to a second temperature for a second period of time to homogenize the lithium-containing silicon-based particles, wherein the second temperature ranges from 550° C. to 850° C., the second period of time ranges from 1 hour to 16 hours; and
immersing the homogenized lithium-containing silicon-based particles into a passivation solution or a passivation gas, and heating the homogenized lithium-containing silicon-based particles to a third temperature for a third period of time to passivate the homogenized lithium-containing silicon-based particles, wherein the passivation solution consists of a hexane mixed with a perfluorotripentylamine (FC70) or a second tetrahydrofuran mixed with a hydrofluoric acid, a first weight percentage of the perfluorotripentylamine is equal to or less than 5 wt. %, a second weight percentage of the hydrofluoric acid is equal to or less than 10 wt. %, the passivation gas is a nitrogen trifluoride or a chlorofluorocarbon (Freon), the third temperature ranges from 30° C. to 250° C., and the third period of time ranges from 10 minutes to 24 hours,
wherein the passivated and homogenized lithium-containing silicon-based particles serve as the silicon-based anode active material.

2. The method of claim 1, wherein a concentration of the carrier solution ranges from 0.025M to 2M.

3. The method of claim 2, wherein the mole ratio of the lithium source to the polycyclic aromatic hydrocarbon ranges from 5 to 100.

4. The method of claim 3, wherein a pH value of the silicon-based anode active material is equal to or less than 12.

5. The method of claim 4, wherein in the step of homogenizing the plurality of lithium-containing silicon-based particles, a phosphorus or a boron is added to generate a phosphorus oxide or a boron oxide on a surface of one of the plurality of lithium-containing silicon-based particles, and further to reduce the pH value of the silicon-based anode active material, a weight ratio of an amount of the phosphorus or the boron added to the plurality of lithium-containing silicon-based particles is equal to or less than 10%.

6. A manufacturing equipment for manufacturing a silicon-based anode active material, comprising:
a stirred reaction chamber, wherein a plurality of silicon-based particles, a lithium source and a polycyclic aromatic hydrocarbon are placed into the stirred reaction chamber, each of the silicon-based particles is coated with a carbon film, and has a chemical formula of SiOₓ/C, 0<x<2, the stirred reaction chamber is sealed, the polycyclic aromatic hydrocarbon is one selected from the group consisting of a biphenyl, a naphthalene, a biphenyl containing a functional group and a mixture therebetween;
an inert gas supply source, communicating with the stirred reaction chamber and therein storing an inert gas;
a solvent supply source, communicating with the stirred reaction chamber and therein containing a solvent, wherein the solvent is one selected from the group consisting of a first tetrahydrofuran, a dimethoxyethane, an N-methyl-2-pyrrolidone and a mixture therebetween;
a passivation source supply source, communicating with the stirred reaction chamber and therein containing a passivation solution or a passivation gas, wherein the passivation solution consists of a hexane mixed with a perfluorotripentylamine (FC70) or a second tetrahydrofuran mixed with a hydrofluoric acid, a first weight percentage of the perfluorotripentylamine is equal to or less than 5 wt. %, a second weight percentage of the hydrofluoric acid is equal to or less than 10 wt. %, the passivation gas is a nitrogen trifluoride or a chlorofluorocarbon (Freon);
a first recycling apparatus, communicating with the stirred reaction chamber; and
a second recycling apparatus, communicating with the stirred reaction chamber;
wherein the solvent supply source supplies the solvent to the stirred reaction chamber, the polycyclic aromatic hydrocarbon is mixed with the solvent to form a carrier solution, and the plurality of silicon-based particles and the lithium source are immersed into the carrier solution;
the inert gas supply source supplies the inert gas to the stirred reaction chamber resulting in an inert furnace atmosphere in the stirred reaction chamber;
the stirred reaction chamber is heated to a first temperature for a first period of time to obtain a plurality of lithium-containing silicon-based particles, the first temperature ranges from 50° C. to 250° C., the first period of time ranges from 1 hour to 24 hours, the first recycling apparatus recycles the carrier solution;
the stirred reaction chamber is, in the inert furnace atmosphere, heated to a second temperature for a second period of time to homogenize the lithium-containing silicon-based particles, the second temperature ranges from 550° C. to 850° C., the second period of time ranges from 1 hour to 16 hours;
the passivation source supply source supplies the passivation solution or the passivation gas to the stirred reaction chamber;
the stirred reaction chamber is heated to a third temperature for a third period of time to passivate the homogenized lithium-containing silicon-based particles, the third temperature ranges from 30° C. to 250° C., and the third period of time ranges from 10 minutes to 24 hours;
the second recycling apparatus recycles the passivation solution or the passivation gas;
the passivated and homogenized lithium-containing silicon-based particles serve as the silicon-based anode active material.

7. The manufacturing equipment of claim 6, wherein when the first recycling apparatus recycles the carrier solution, the reaction chamber is heated higher than a boiling point of the carrier solution.

8. The manufacturing equipment of claim 7, wherein a concentration of the carrier solution ranges from 0.025M to 2M.

9. The manufacturing equipment of claim 8, wherein a mole ratio of the lithium source to the polycyclic aromatic hydrocarbon ranges from 5 to 100.

10. The manufacturing equipment of claim 8, wherein a pH value of the silicon-based anode active material is equal to or less than 12.
